(19) United States
(12) Patent Application Publication
(10) Pub. No.: US 2008/0192796 A1
(43) Pub. Date: Aug. 14, 2008

(54) Method and Device for Operating an Electric-Arc Furnace

(76) Inventors: Thomas Matschullat, Eckental (DE); Uwe Sturmer, Baiersdorf (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/573,997

(22) PCT Filed: Aug. 11, 2005
(86) PCT No.: PCT/EP2005/053959

§ 371 Date: Aug. 6, 2007

(30) Foreign Application Priority Data
Aug. 20, 2004 (DE) 10 2004 040 494.1

(51) Int. Cl. H05B 7/148

(52) U.S. Cl. 373/104

(57) ABSTRACT

A method for operating an electric-arc furnace with at least one electrode has one tapping method step. At the beginning of the tapping step, the energy supply to the at least one electrode (2) of the electric-arc furnace (1) is not stopped and the energy is still supplied to the at least one electrode (2) even during the tapping step. The step can begin before the traditional operating methods of an electric-arc furnace (1). This saves time, reduces the consumption of electrodes and energy, and also increases productivity. The desired energy content of the raw steel (8) is secured by the pre-calculation of the alteration of the energy content of the melt (4) during the tapping step and the danger of over-heating is compensated.

### CROSS-REFERENCE TO RELATED APPLICATIONS

This application is a U.S. national stage application of International Application No. PCT/EP2005/053959 filed Aug. 11, 2005, which designates the United States of America, and claims priority to German application number DE 10 2004 040 494.1 filed Aug. 20, 2004, the contents of which are hereby incorporated by reference in their entirety.

### TECHNICAL FIELD

The invention relates to a method for operating an electric-arc furnace comprising at least one electrode and one tapping method step. Furthermore the invention relates to a corresponding device.

### BACKGROUND

Charge materials containing in particular iron are melted and/or treated in an electric-arc furnace. Electrical energy serves in the electric-arc furnace preferably to heat, melt and superheat and/or clean the charge materials. In electric-arc furnaces, heat is generated by electric arcs, i.e. by electric current flowing between electrodes or between one or more electrodes and furnace elements, with the electric arcs giving off their energy to the charge materials to be melted and to the melt in the electric-arc furnace.

Steel production in the electric-arc furnace is described in “Stahlerzeugung im Lichtbogenofen” by Manfred Jellinghaus, 1994, Verlag Stahleisen mbH, Düsseldorf. Pages 100 and 101 of the above-mentioned publication, in particular, go into the operation of electric-arc furnaces in more detail. In order to achieve the highest possible productivity in an electric-arc furnace, attempts are made to melt the charge materials as quickly as possible, to supply the highest possible electrical energy during the entire melting time and to keep the power-off or non-productive times without energy supply as short as possible. It is proposed, for example, that in order to increase the productivity of electric-arc furnaces, more powerful furnace transformers are used, or that the material flow of all the raw materials to the electric-arc furnace is organized better.

### SUMMARY

The object of the invention is to further improve the productivity of an electric-arc furnace. This object is achieved by a method of the type mentioned at the beginning, whereby energy is supplied to the at least one electrode of the electric-arc furnace at least for part of the time even during the tapping method step.

By contrast with known methods of operation of an electric-arc furnace, according to an embodiment, the energy supply to the at least one electrode is no longer switched off before the tapping method step. Instead energy continues to be supplied at least part of the time even during the tapping method step. In this way the tapping method step can start earlier than with the traditional method of operation. Compared with the traditional method of operation of an electric-arc furnace, this results in a significant saving in time. The productivity of an electric-arc furnace is thus increased and the electrode consumptions are reduced due to the shorter operating times.

The energy content of the melt in the electric-arc furnace is advantageously increased even during the tapping method step. This further increases the productivity of the electric-arc furnace and a lower overall energy consumption is achieved.

The energy supply is advantageously controlled by means of the inputs by an operator. The method can thus be implemented with extremely little advance investment cost.

The energy supply is advantageously controlled by means of a meter. As a result, calculations and evaluations associated with the operation of the electric-arc furnace in particular no longer have to be carried out by an operator.

The energy supply is advantageously controlled by means of a model for the energy and mass balance implemented in a control device. An extremely fast-reacting and extensively automated control method for the operation of an electric-arc furnace is thus provided.

The object of the invention is also achieved by a device for performing the method described above in its various forms, with an electric-arc furnace and a control device connected to the electric-arc furnace, with the control device comprising a model for the energy and mass balance and being configured in such a way that it controls the position and the energy supply of the at least one electrode of the electric-arc furnace even during the tapping method step. The advantages of the device according to the invention can be derived by analogy with the advantages of the method according to the invention.

### BRIEF DESCRIPTION OF THE DRAWINGS

Details and further advantages of the invention are explained in further detail below by reference to exemplary embodiments in conjunction with the drawings, in which

FIG. 1 shows an exemplary schematic representation of an electric-arc furnace,

FIG. 2 shows an exemplary schematic representation of the energy distribution during the traditional operation of an electric-arc furnace,

FIG. 3 shows an exemplary schematic representation of the energy distribution during the operation of an electric-arc furnace according to the invention.

### DETAILED DESCRIPTION

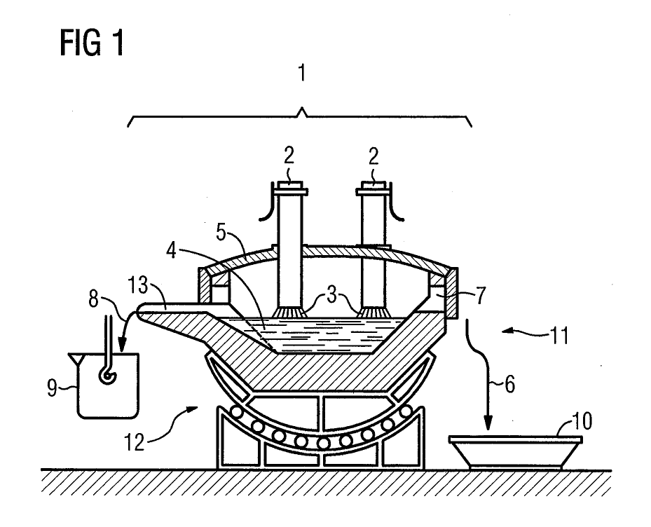

FIG. 1 shows an embodiment of an electric-arc furnace 1 with a furnace vessel 11 and a vessel substructure 12 with furnace scales. In the embodiment shown there is a cover 5 in the upper area of the furnace vessel. In the embodiment shown the cover 5 is movable and can preferably be opened for admitting charge materials to the furnace vessel 11, for example.

In the embodiment, melt 4 is shown located in the furnace vessel 11. The designation “melt” 4 is used to refer to both charge materials in the electric-arc furnace 1 and to melted material. Melt 4 is also used to refer to a mixture of charge materials and melted material. Charge materials are, for example, scrap, i.e. ferrous wastes, crude iron and/or sponge iron. Additives such as slag forming agents, fluxes, refining agents, carbonizing agents, slag reduction agents and/or additions such as deoxidation and alloying agents are frequently added to the melt 4.

In the embodiment shown, the electric-arc furnace 1 has several electrodes 2 that are inserted through openings in the cover 5. By means of the electrodes 2 and by supplying energy, electric arcs 3 are created by means of which energy is supplied to the melt 4 in the form of heat.

The electric-arc furnace 1 can be designed, for example, as a direct current (DC) electric-arc furnace or as an alternating current (AC) electric-arc furnace. A control device not shown in further detail in the drawing is preferably provided for the electric-arc furnace 1. This control device has an electrode control device to allow the power conversion in the electric-arc furnace 1 to be set in the desired manner by adjusting the electrodes 2. The ignition of the electric arcs 3, the setting of the arc length and the compensation of the burn-off are achieved essentially by raising and lowering the electrodes 2. Particularly during melting of material in the electric-arc furnace 1, the electrodes 2 are mostly adjusted so quickly that the electric arcs 3 are not interrupted and short-circuits that can occur, for example, due to the collapse of scrap are compensated within a minimum of time by a rapid upward movement of the electrodes 2.

The electric-arc furnace 1 preferably has a door 7 in order to discharge slag 6, for example by means of a slag ladle 10.

At the end of a melt, referred to below also as operating cycle, the finished melt 4 is discharged from the electric-arc furnace 1 as raw steel 8. The discharge of the finished melt 4, i.e. the removal of raw steel 8 from the electric-arc furnace 1, is referred to as tapping method step. The raw steel 8 is transferred from the electric-arc furnace 1 into a ladle 9 via the tapping spout 13 that in the embodiment shown is designed as a siphon tap. The furnace vessel 11 is preferably tilted during this process. After the tapping method step, the raw steel 8 can be transferred to a casting device, for example a continuous casting plant, by means of the ladle 9 that is also referred to as a pouring ladle.

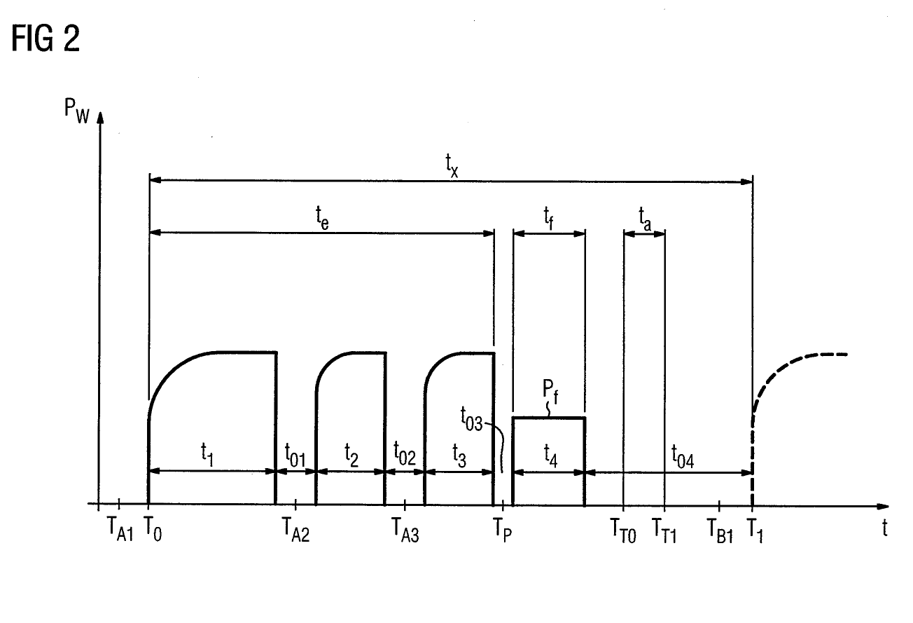

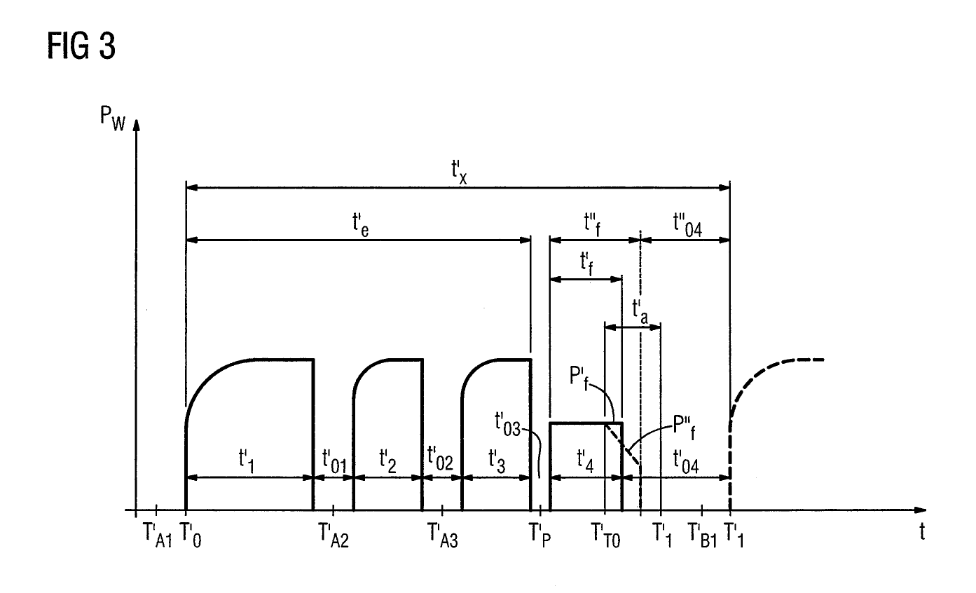

FIGS. 2 and 3 show diagrammatically and by way of example the energy distribution during the operation of an electric-arc furnace 1. FIG. 2 refers to the traditional method of operation of an electric-arc furnace 1, while in contrast, FIG. 3 illustrates the method of operation of an electric-arc furnace 1 according to the invention.

In each of FIGS. 2 and 3, the effective power P_{W} is plotted against time t. FIGS. 2 and 3 both show the energy distribution during a complete operating cycle of the electric-arc furnace 1 and merely as an indication the start of a temporally following operating cycle. The temporally preceding operating cycle that is shown in full is referred to below as the first operating cycle; the temporally following operating cycle, the start of which is only indicated in FIGS. 2 and 3, is referred to below as the second operating cycle. During operation of an electric-arc furnace 1 there are generally several—often a large number of—consecutive operating cycles. Additional standstill, installation and/or maintenance periods can lie between two operating cycles, with great efforts being made to minimize these periods in the striving for the highest possible furnace utilization.

Charge materials are charged into the electric-arc furnace 1 at the times T_{A1}, T_{A2} and T_{A3} or T′_{A1}, T′_{A2} and T′_{A3} during the first operating cycle. The charge materials are generally charged into the furnace vessel 11 by means of a basket or bucket with the cover 5 open.

After charging of the charge materials into the electric-arc furnace 1, energy is supplied to the electrodes 2 during the power-on periods t₁, t₂ and t₃ or t′₁, t′₂ and t′₃. During the power-on periods t₁, t₂, t₃ or t′₁, t′₂, t′₃, melt 4 is melted and/or treated in some other way in the furnace vessel 11. The power-on periods t₁, t₂, t₃ or t′₁, t′₂, t′₃ are followed by power-off periods t₀₁, t₀₂, t₀₃ or t′₀₁, t′₀₂, t′₀₃ during which no energy is supplied.

During a final power-on period t₄ or t′₄ it is necessary to ensure that the energy content of the raw steel 8 is high enough during tapping and correctly set for its further treatment.

During the power-off periods t₀₁, t₀₂ or t′₀₁, t′₀₂, charge materials can be charged as already described, for example. At least during the power-off period t₀₃ or t′₀₃ that precedes the last power-on period t₄ or t′₄ of the first operating cycle, at least one sample is taken from the melt 4 at the moment T_{P} or T′_{P}.

The time interval from moment T₀ or T′₀, the start of the first power-on period t₁ or t′₁ of the first operating cycle, up to the end of the last-but-one power-on period t₃ or t′₃ of an operating cycle, is referred to as the melting time tₑ or t′ₑ. The last power-on period t₄ or t′₄ is also referred to as the finishing time t_{f} or t′_{f} or t″_{f}.

It is important to set the energy content of the melt 4 or of the raw steel 8 correctly during the finishing time t_{f}, t′_{f} or t″_{f}. Refining and/or purification of the melt 4 can also take place during the finishing time t_{f}, t′_{f} or t″_{f}.

The last power-on period t₄ or t′₄ of the first operating cycle, in other words the finishing time t_{f}, t′_{f} or t″_{f} of the first operating cycle, is followed by a final power-off period t₀₄, t′₀₄ or t″₀₄ that lasts until moment T₁ or T′₁, the start of the first power-on period of the second operating cycle. The time interval from moment T₀ or T′₀, the start of the first power-on period t₁ or t′₁ of the first operating cycle, up to the moment T₁ or T′₁, the start of the first power-on period of the second operating cycle, is referred to as the cycle time tₓ or t′ₓ.

In the traditional method of operation of an electric-arc furnace 1, no energy is supplied to the electrodes 2 during the tapping method step (cf. FIG. 2). In the traditional method of operation, the tapping time tₐ, i.e. the time from moment T_{T0}, the start of the tapping method step, up to moment T_{T1}, the end of the tapping method step, lies completely within the last power-off period t₀₄. The finishing energy level P_{f} generally lies significantly below the average energy level during the power-on periods t₁, t₂ and t₃ during the melting time tₑ.

According to the invention, energy is supplied to the electrodes 2 of the electric-arc furnace 1 for at least part of the time during the tapping method step, i.e. during the tapping time t′ₐ, as indicated in FIG. 3. By comparison with the traditional method of operation of an electric-arc furnace 1, the tapping process according to the invention begins significantly earlier, offering savings in time in operation of the electric-arc furnace 1. The cycle time t′ₓ during operation of an electric-arc furnace 1 according to the invention is thus shortened by comparison with the cycle time tₓ for traditional operation.

According to the invention, the energy content of the melt 4 in the electric-arc furnace 1 is also selectively increased even during the tapping method step, i.e. during the tapping time t′ₐ. First of all, the energy state of the melt is determined before the moment T′_{T0}, the start of the tapping method step, and the further change in the energy content of the melt 4 is pre-calculated by means of a melting controller that can be designed e.g. as a meter and/or using an online process tracking model for the energy and mass balance. The optimum moment T′_{T0}, the start of the tapping method step, and the optimum moment T′_{T1}, the end of the tapping method step, are also preferably pre-calculated by means of a melting controller and/or a model for the energy and mass balance. The model for the energy and mass balance can be implemented in a control device. The model for the energy and mass balance is preferably implemented in the control device that comprises the electrode controller for the electric-arc furnace 1. Alternatively there is a first control device that comprises a model for the energy and mass balance that is connected to a second control device that comprises the above-mentioned electrode controller. Alternatively or additionally, the method of operation of the electric-arc furnace 1 can be influenced by an operator.

The model for the energy and mass balance is used to prevent any melting through of the furnace vessel 11 and/or of the vessel substructure 12 by a corresponding control of the energy supply to the electrodes 2. The energy level during the finishing time t′_{f} or t″_{f} can preferably be steadily reduced (cf. finishing energy level P″_{f}) during the tapping time t′ₐ. The finishing energy level P′_{f} or P″_{f} can also be reduced, for example, in steps and/or according to a prolonged, initially constant curve. The latter alternatives are not, however, shown in further detail in FIG. 3. The energy level during the finishing time t′_{f} or t″_{f} can also be held more or less constant during the tapping time t′ₐ (cf. finishing energy level P′_{f}). Two examples of a curve of the energy level according to the invention during the tapping time t′ₐ are shown diagrammatically, plotting the finishing times t′_{f} and t″_{f} against the finishing energy levels P′_{f} and P″_{f}.

In both the method of operation according to the invention and the traditional method of operation of the electric-arc furnace 1, an operating cycle can comprise one or more power-on periods t₁, t₂, t₃ or t′₁, t′₂, t′₃ during its melting time tₑ or t′ₑ. It is fundamentally also possible that in an operating cycle the finishing time t_{f} or t′_{f} is not preceded by a melting time tₑ or t′ₑ. After the tapping time tₐ or t′ₐ, charge materials are again charged into the electric-arc furnace 1 before the moment T₁ or T′₁ at a moment T_{B1} or T′_{B1}.

The fundamental concept for the invention can be essentially summarized as follows. The invention relates to a method for operating an electric-arc furnace comprising at least one electrode and one tapping method step. By not switching off the energy supply via the at least one electrode 2 of the electric-arc furnace 1 at the beginning of the tapping method step and continuing to supply energy to the at least one electrode 2 even during the tapping method step, the tapping method step can start earlier than with the traditional method of operation of an electric-arc furnace 1.

This saves time, reduces the consumption of electrodes and energy, and also increases productivity. The desired energy content of the raw steel 8 is ensured by the pre-calculation of the alteration of the energy content of the melt 4 during the tapping step and the danger of over-heating is compensated.

What is claimed is:

1. A method for operating an electric-arc furnace with at least one electrode, comprising:
performing a tapping method step in an operating cycle of the electric-arc furnace comprising a sequence of a power-on period, a power-off period and a last power-on period, wherein energy being supplied to the at least one electrode during the power-on periods and no energy being supplied during the power-off period, wherein the tapping method step being performed after the power-off period, and wherein energy being supplied to the at least one electrode at least for part of the time even during the tapping method step.

2. The method according to claim 1, wherein the energy content of a melt in the electric-arc furnace is selectively increased even during the tapping method step.

3. The method according to claim 1, wherein the energy supply is controlled by means of inputs by an operator.

4. The method according to claim 1, wherein the energy supply is controlled by means of a meter.

5. The method according to claim 1, wherein the energy supply is controlled by means of a model for the energy and mass balance implemented in a control device.

6. The method according to claim 1, wherein the beginning of the tapping method step lies in the last power-on period and the end of the tapping method step lies in a final power-off period following the last power-on period.

7. The method according to claim 6, wherein the energy supply in the last power-on period steadily decreased during the tapping method step.

8. The method according to claim 6, wherein the energy supply in the last power-on period is decreased in steps and/or according to a prolonged, initially constant curve.

9. A device for performing a method according to claim 5, with an electric-arc furnace and a control device connected to the electric-arc furnace, wherein the control device comprises a model for the energy and mass balance and is configured in such a way that it controls the position and the energy supply to the at least one electrode even during the tapping method step.

10. A device for operating an electric-arc furnace with at least one electrode, comprising:
means for performing a tapping method step in an operating cycle of the electric-arc furnace comprising a sequence of a power-on period, a power-off period and a last power-on period, wherein energy being supplied to the at least one electrode during the power-on periods and no energy being supplied during the power-off period, wherein the device is operable to perform the tapping method step after the power-off period, and wherein energy being supplied to the at least one electrode at least for part of the time even during the tapping method step.

11. The device according to claim 10, wherein the energy content of a melt in the electric-arc furnace is selectively increased even during the tapping method step.

12. The device according to claim 10, wherein the energy supply is controlled by means of inputs by an operator.

13. The device according to claim 10, wherein the energy supply is controlled by means of a meter.

14. The device according to claim 10, wherein the energy supply is controlled by means of a model for the energy and mass balance implemented in a control device.

15. The device according to claim 10, wherein the beginning of the tapping method step lies in the last power-on period and the end of the tapping method step lies in a final power-off period following the last power-on period.

16. The device according to claim 15, wherein the energy supply in the last power-on period is steadily decreased during the tapping method step.

17. The device according to claim 15, wherein the energy supply in the last power-on period is decreased in steps and/or according to a prolonged, initially constant curve.
